(19) United States
(12) Patent Application Publication
(10) Pub. No.: US 2006/0290081 A1
(43) Pub. Date: Dec. 28, 2006

(54) Multi-function child transporter

(76) Inventor: Stephen Baum, New York, NY (US)

Correspondence Address: NOTARO AND MICHALOS, 100 DUTCH HILL ROAD, SUITE 110, ORANGEBURG, NY, 10962-2100, US

(21) Appl. No.: 11/197,269

(22) Filed: Aug. 4, 2005

Related U.S. Application Data
(60) Provisional application No. 60/694,192, filed on Jun. 27, 2005.

(51) Int. Cl. B62D 63/00

(52) U.S. Cl. 280/32.7

(57) ABSTRACT

A child transporting apparatus includes a riding board having a horizontal use position for a child to stand on, and a collapsed position. The riding board has front and rear wheels for rolling along a surface and a support column having a lower end attached the riding board and an upper end. The column is collapsible and a handle bar is connected to the upper end of the column to be held by a child riding on the riding board. A pulling handle is pivotally connected to the column and movable between a collapsed position laying adjacent the column and a use position extending from the column, and at least one strap is connected to the column for carrying the apparatus like a backpack.

### CROSS-REFERENCE TO RELATED APPLICATIONS

This application claims priority on U.S. Provisional Patent Application 60/694,192, filed Jun. 27, 2005, which is incorporated here by reference.

### FIELD AND BACKGROUND OF THE INVENTION

The present invention relates generally to the field of strollers, and, in particular, to a new and useful child transporting apparatus.

A wide variety of carriages and strollers have been used over the years for transporting infants and young children. These include folding strollers which can be folded and carried when necessary.

While most strollers are meant to be pushed from behind, some stroller-like or other child transporting devices are designed to be pulled behind another wheeled vehicle. See, for example, U.S. Pat. No. 5,301,963 to Chen which discloses a convertible stroller that can be pulled behind a bicycle and U.S. Pat. No. 6,851,693 to Haeggberg which discloses a stroller trailer that can be pulled behind another stroller.

Devices called wheel boards are also known which are wheeled platforms designed to be engaged to the rear axle of a stroller. A child stands on the platform and, while holding onto the stroller, can be pushed along with the stroller. A product known as the KIDDY BUGGY BOARD (a trademark) is an example of such a device.

See the link: http://www.chariotsatp.co.uk/products/buggy_board.htm.

A trailer device to be pulled behind a stroller and having wheels and a seat for a child is called the Strolli Rider and is available from Britax Excel Travel. See: https://shop.babyworld.co.uk/DisplayDetail.aspx?which=637.

A wide variety of hand-trucks, luggage carriers and special purpose wheeled carriers that are meant to be pulled behind a walking person are also know. See, for example, U.S. Pat. No. 6,688,636 to Han for a light-product structure.

Other examples of wheeled carrying devices or component structures that are usable for such, follow:

U.S. Pat. No. 6,431,556 to Beardsley, et al. discloses a golf cart towing device. U.S. Pat. No. 6,520,517 to Chung, et al. discloses a scooter-like riding device including a deck upon which a rider is supported. U.S. Pat. No. 6,481,729 to Herman, et al. discloses a scooter that can be folded from an assembled configuration to a compact configuration. U.S. Pat. No. 6,318,741 to Chen discloses a clamp structure for a folding skateboard. U.S. Pat. No. 6,282,981 to Tsai teaches a handlebar height adjustable device for a skate cart. U.S. Pat. No. 5,820,146 to Van Ligten discloses a hand cart for the transport of persons and luggage. U.S. Pat. No. 6,409,188 Hesmer teaches a carrying apparatus for golf bag pull cart and golf bag. U.S. Pat. No. 5,421,597 to Berner discloses a convertible infant stroller and trailer with quick release hitch. U.S. Pat. No. 5,779,248 to Gold, et al. discloses a wheeled child carrier that allows a standard back-mounted child carrier to also serve as a stroller.

### SUMMARY OF THE INVENTION

An object of the present invention is to provide a child transporting apparatus which is foldable and sufficiently light and convenient to be carried during outings when a stroller is either not convenient or acceptable to the child as a mode of transportation, or when more than one child is coming on the stroll, an older child who does not wish to ride in the stroller, and a younger one who still appreciated the luxury of riding.

A problem not addressed by any know device of the prior art, involves the needs of children who feel they are too old to occupy a stroller but who may still become too tired to walk during an outing. These children, who are usually about 3 to 6 years old but may be older or younger, then wish to be carried. Another object of the present invention is to provide a parent or care-giver a versatile and convenient option in this case.

Accordingly, another object of the present invention is to provide a child transporting apparatus which comprises a riding board having a substantially horizontal use position so that a child can stand on the riding board, the riding board having a collapsed position with at least part of the riding board extending substantially vertically, a plurality of spaced apart wheels mounted for rotation to the riding board for allowing the riding board to be rolled along a surface, a substantially vertical support column having a lower end attached the riding board and an upper end, the column being collapsible from an expanded use position to a shortened collapsed position, a handle bar connected to the upper end of the column and adapted to be held by a child riding on the riding board, a pulling handle pivotally connected to the column and movable between a collapsed position laying substantially adjacent the column and a use position extending from the column and at least one strap connected to column for carrying the apparatus.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a perspective view of one embodiment of the invention, in its extended use position;

FIG. 2 is a side elevational view of the embodiment of FIG. 1, in a collapsed carry position;

FIG. 3 is a side elevational view of the embodiment of FIG. 1, in the extended use position;

FIG. 4 is a front elevational view of the embodiment of FIG. 1, in the extended use position;

FIG. 5 is a composite, side elevational view of the embodiment of FIG. 1, in a position for use as a wheel board to be engaged to the rear of a stroller;

FIG. 6 is a perspective view of a second embodiment of the invention, in its extended use position; and

FIG. 7 is a composite illustration showing the various modes of use of the present invention.

### DESCRIPTION OF THE PREFERRED EMBODIMENTS

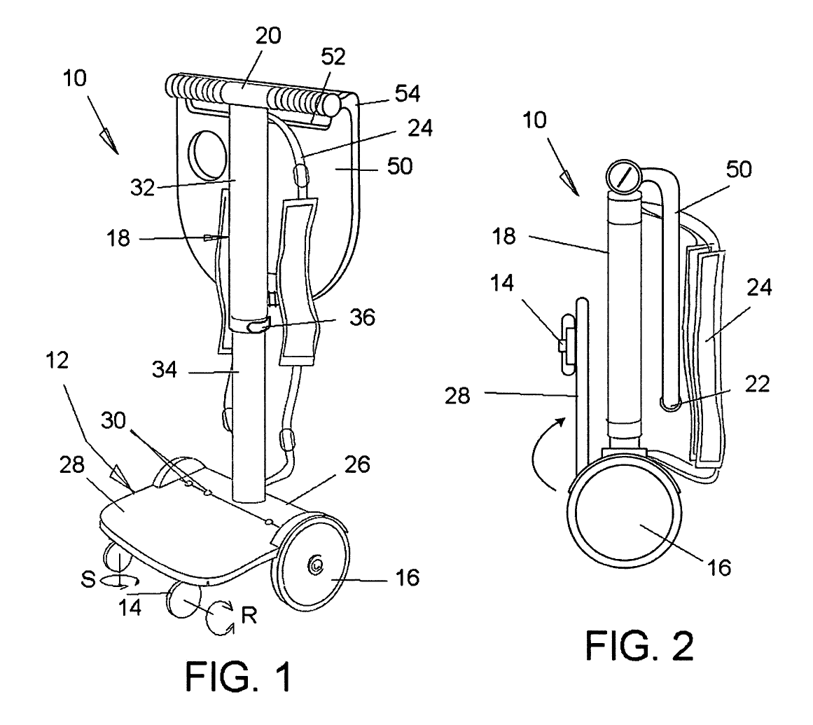

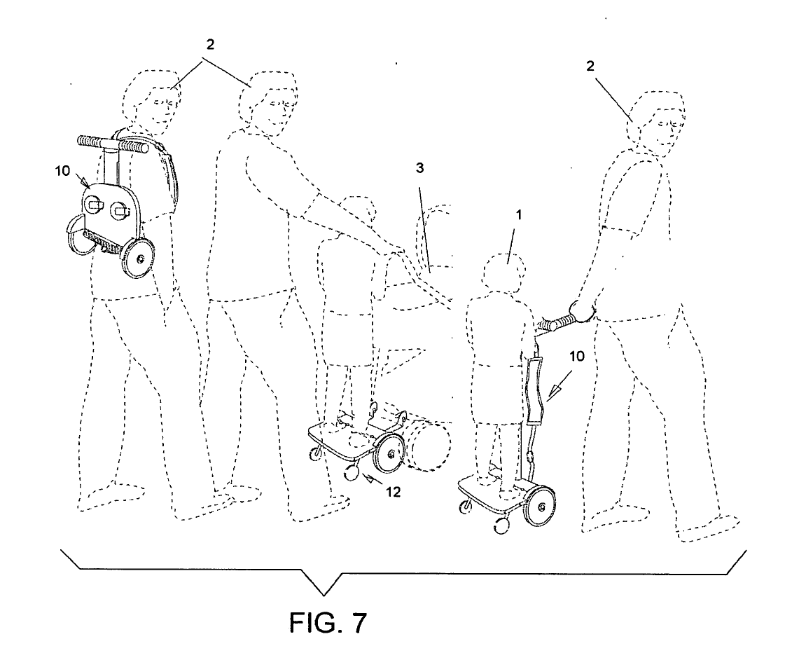

Referring now to the drawings, in which like reference numerals are used to refer to the same or similar elements, FIG. 1 shows a child transporting apparatus 10 comprising a riding board 12 having a substantially horizontal use position in FIG. 1, so that a child 1, shown in the right most section of FIG. 7, can stand on the riding board and be pulled along by a parent or care-giver 2.

The riding board 12 also has a collapsed position shown on FIG. 2, with at least part of the riding board extending substantially vertically. A plurality of spaced apart wheels, preferably four wheel 14, 14, and 16, 16, are mounted for rotation to the riding board for allowing the riding board to be rolled along a surface, such as the ground.

A substantially vertical support column 18, has a lower end attached the riding board 12 and an upper end. The column is collapsible from an expanded use position shown in FIG. 1, to a shortened collapsed position shown in FIG. 2.

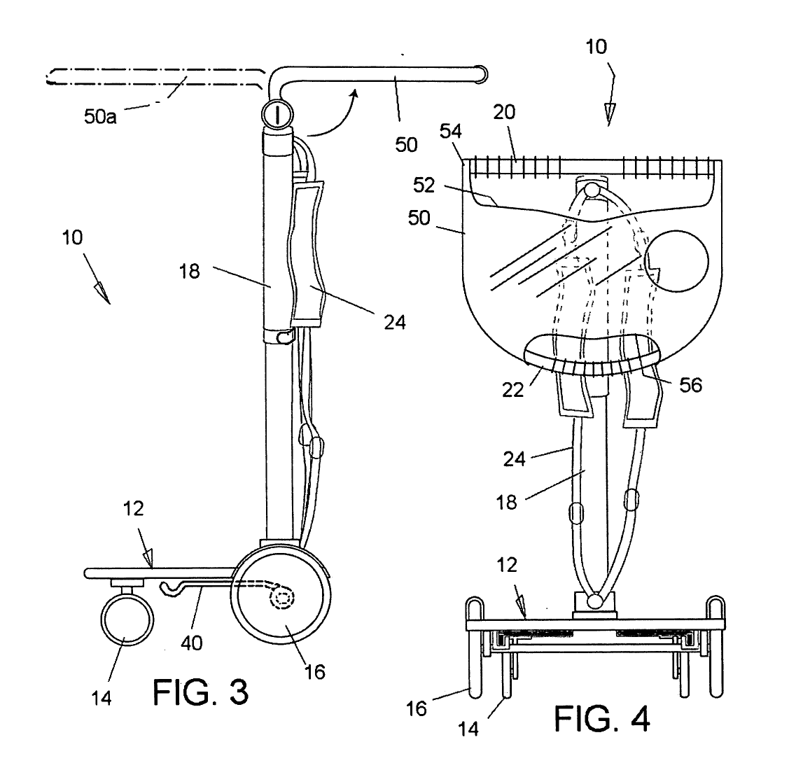

A handle bar 20 is connected to the upper end of the column 18 and is adapted to be held by a child riding on the riding board as shown in FIG. 7, right hand section. A pulling handle 22 is pivotally connected to the column 18 and movable between a collapsed position shown in FIGS. 2 and 4, laying substantially adjacent the column 18, and a use position shown in FIG. 3, extending outwardly from the column.

At least one, but preferably two shoulder straps 24 are connected to column for carrying the apparatus like a backpack, when it is collapsed, as illustrated in FIG. 7, left hand section. The ends of the strap or straps 24 can be connected to the respective top and bottom ends of the column 18, or be connected indirectly to the column by connection to other parts of the apparatus, such as to the handle bar 20 and the riding board 12.

The riding board 12 includes a base 26 attached to the column 18 and a platform 28 pivotally mounted, e.g. at hinges 30, to the rear edge of the base 26 for movement from the substantially horizontal use position which is substantially perpendicular to the column and can be locked in that position for use (FIG. 1), to the collapsed position of FIG. 2, whereat the platform is substantially parallel to the column.

The plurality of wheels 14, 16, includes a pair of front wheels 16 mounted for rotation to the base, e.g. on an axle journaled to the base, and at least one rear wheel 14 mounted for rotation the platform. The rear wheel or pair of rear wheels 14, are preferably foldable from a use position shown in FIG. 1, with their axis of rotation parallel to the plane of the platform 28 and extending substantially perpendicular to the platform, to a collapsed position shown in FIG. 2, substantially parallel to the platform and with their axis of rotation perpendicular to the platform plane. The pair of rear wheels 14 are preferably caster wheels mounted for rotation to the platform, e.g. about arrow R, and for swivelling to the platform about arrow S in FIG. 1. The rear caster wheels are foldable from a use position extending substantially perpendicular to the platform, to a collapsed position substantially parallel to the platform.

The front wheels 16 are preferably larger than the smaller rear caster wheels 14 and both have rubber or other elastomeric tires to improve their rolling characteristics. The platform and base of the riding board 12 are also preferably between the front wheels 16 for this purpose and for stability of the apparatus during use.

The column 18 preferable comprises two or more elongated members such as cylindrical tubes 32 and 34, that are telescopically engaged with each other for movement from the expanded use position of FIG. 1, there they can be locked in the elongated position, e.g. by a latch or lock 36 of the type that is common in scooters (e.g. see U.S. Pat. No. 6,318,741 to Chen), to the shortened collapsed position of FIG. 2.

The column 18 may, in the alternative, comprise at least two elongated members that are hinged or otherwise articulated to each other for movement from the expanded use position to the shortened collapsed position.

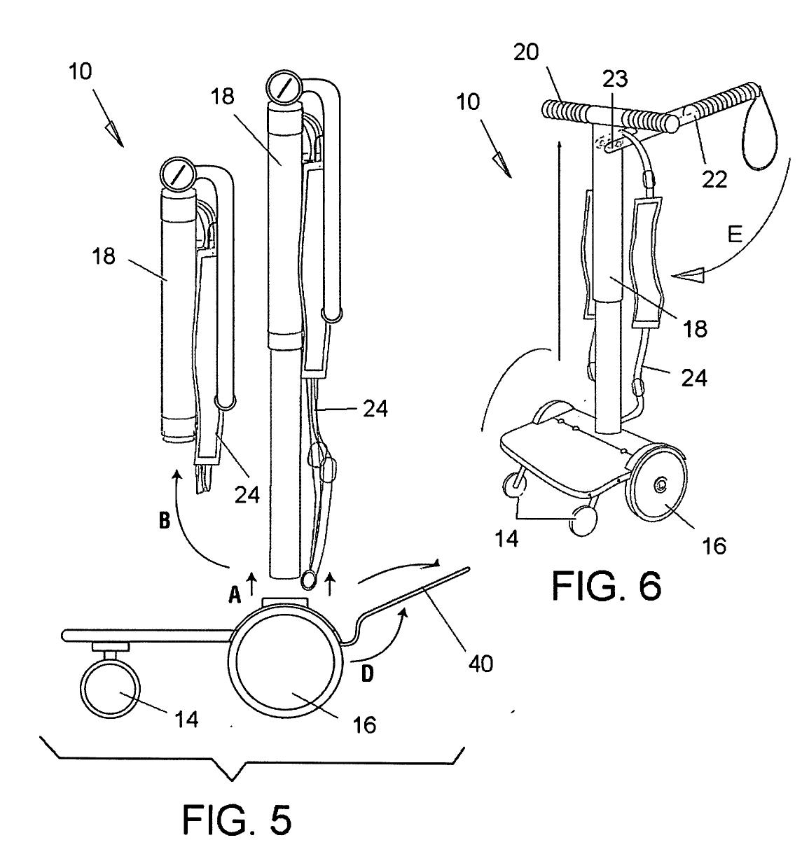

The apparatus 10 may also include at least one, but better, two, stroller engagement members such as stroller hooks 40 shown in FIG. 3 in a stored position under the platform 12. Members 40 are moveably mounted to the riding board 12 between the stored position, to an extended position shown in FIG. 7, middle section, for engaging a stroller, e.g. the rear axle of the stroller, for connecting the apparatus to a stroller. For this use of the apparatus of the invention, the column 18 is preferably detachably attached to the riding board 12 for removal of the column in the directions of the arrows A and B in FIG. 5, when the riding board is to be connect to a stroller. In that position, a child 1 can ride behind the stroller 3 while standing on the riding board and holding onto the handle of the stroller, as the stroller is being pushed by the parent or care-giver 2.

FIG. 5 illustrates an alternate form of the stroller engaging members 40 that can be swung from the stored position in the direction of arrow D, to the position of use where they can be connected to the rear of a stroller.

In the embodiment of FIGS. 1-5, the apparatus 10 includes a tray 50 pivotally mounted near the upper end of the column 18, between a collapsed position of FIGS. 2, 4 and 5, that is substantially parallel to the column, and a locked use position of FIG. 3, extending substantially perpendicularly to the column, the pulling handle 22 being incorporated into an outer end of the tray.

As best shown in FIGS. 1 and 4, the handle bar 20 may comprise a pair of elongated handles on opposite sides of the column in the form of a T, the tray having a first recess 52 on a first side of the tray connected to the column with a pair of spaced apart projections 54 pivotally connected to respective outer ends of the handles for pivotally connecting the tray to the column. The tray 50 also has a second recess 56 on a second side of the tray which is opposite to the first recess, the pull handle 22 extending across the second recess 56 and connected to the tray on opposite sides of the recess.

As shown in FIG. 3 the tray, in its use position can also be rotatably mounted to the top of the column 18 about a substantially vertical axis, so that it can be rotated around from the use position shown in solid line at 50 in FIG. 3, to a stable serving position 50a in phantom line in FIG. 3, over the riding board 12 which then functions as a support or leg for the tray. In this serving position, the column 18 can be collapsed, partly or fully, to lower the tray to a better level, for example, for use as a table with the child and the care-giver sitting at a park bench.

FIG. 6 illustrated another embodiment of the apparatus 10. This is the embodiment used to show the various purposed for the invention in FIG. 7, but it is understood that the embodiment of FIG. 1-5 can like-wise be used in the same way.

The apparatus 10 of FIG. 6 has no tray but used an elongated pull handle 22, that is pivotally connected near the top of the column 18, e.g. by a pair of arms 23 connected by a pivot pin on opposite sides of the column 18. The handle 22 may be C-shaped in cross-section so that it partly engages around the cylindrical column 18 in the lowered collapsed position when it is moved in the direction of arrow E in FIG. 6, or pull handle 22 may be pivoted to one side of column 18 and lowered to a position next to and parallel to the column in the collapsed position.

An alternate use of the shoulder strap or straps 24, is for engagement with the child as a safety belt or harness.

While a specific embodiment of the invention has been shown and described in detail to illustrate the application of the principles of the invention, it will be understood that the invention may be embodied otherwise without departing from such principles.

What is claimed is:

1. A child transporting apparatus comprising:
a riding board having a substantially horizontal use position so that a child can stand on the riding board, the riding board having a collapsed position with at least part of the riding board extending substantially vertically;
a plurality of spaced apart wheels mounted for rotation to the riding board for allowing the riding board to be rolled along a surface;
a substantially vertical support column having a lower end attached the riding board and an upper end, the column being collapsible from an expanded use position to a shortened collapsed position;
a handle bar connected to the upper end of the column and adapted to be held by a child riding on the riding board; and
a pulling handle pivotally connected to the column and movable between a collapsed position laying substantially adjacent the column and a use position extending from the column.

2. The apparatus of claim 1, including at least one strap connected to column for carrying the apparatus and wherein the riding board includes a base attached to the column and a platform pivotally mounted to the base for movement from the substantially horizontal use position which is substantially perpendicular to the column, to the collapsed position which is substantially parallel to the column, the plurality of wheels including a pair of front wheels mounted for rotation to the base and at least one rear wheel mounted for rotation the platform.

3. The apparatus of claim 1, wherein the riding board includes a base attached to the column and a platform pivotally mounted to the base for movement from the substantially horizontal use position which is substantially perpendicular to the column, to the collapsed position which is substantially parallel to the column, the plurality of wheels including a pair of front wheels mounted for rotation to the base and at least one rear wheel mounted for rotation the platform, the rear wheel being foldable from a use position extending substantially perpendicular to the platform, to a collapsed position substantially parallel to the platform.

4. The apparatus of claim 1, wherein the riding board includes a base attached to the column and a platform pivotally mounted to the base for movement from the substantially horizontal use position which is substantially perpendicular to the column, to the collapsed position which is substantially parallel to the column, the plurality of wheels including a pair of front wheels mounted for rotation to the base and a pair of rear wheels mounted for rotation the platform, the rear wheels being foldable from a use position extending substantially perpendicular to the platform, to a collapsed position substantially parallel to the platform.

5. The apparatus of claim 1, wherein the riding board includes a base attached to the column and a platform pivotally mounted to the base for movement from the substantially horizontal use position which is substantially perpendicular to the column, to the collapsed position which is substantially parallel to the column, the plurality of wheels including a pair of front wheels mounted for rotation to the base and a pair of rear caster wheels mounted for rotation the platform and for swivelling to the platform, the rear caster wheels being foldable from a use position extending substantially perpendicular to the platform, to a collapsed position substantially parallel to the platform.

6. The apparatus of claim 1, wherein the riding board includes a base attached to the column and a platform pivotally mounted to the base for movement from the substantially horizontal use position which is substantially perpendicular to the column, to the collapsed position which is substantially parallel to the column, the plurality of wheels including a pair of large front wheels mounted for rotation to opposite sides of the base, and a pair of small rear caster wheels mounted for rotation the platform, the rear wheels being foldable from a use position extending substantially perpendicular to the platform, to a collapsed position substantially parallel to the platform and the platform being at least partly between the front.

7. The apparatus of claim 1, wherein the column comprises at least two elongated members that are telescopically engaged with each other for movement from the expanded use position to the shortened collapsed position.

8. The apparatus of claim 1, including at least one stroller engagement member moveably mounted to the riding board between a stored position and an extended position for engaging a stroller for connecting the apparatus to a stroller, the column being detachably attached to the riding board for removal of the column from the riding board when the riding board is connect to a stroller.

9. The apparatus of claim 1, wherein the riding board includes a base attached to the column and a platform pivotally mounted to the base for movement from the substantially horizontal use position which is substantially perpendicular to the column, to the collapsed position which is substantially parallel to the column, the plurality of wheels including a pair of large front wheels mounted for rotation to opposite sides of the base, and a pair of small rear caster wheels mounted for rotation the platform, the rear wheels being foldable from a use position extending substantially perpendicular to the platform, to a collapsed position substantially parallel to the platform and the platform being at least partly between the front, the column comprises at least two elongated members that are telescopically engaged with each other for movement from the expanded use position to the shortened collapsed position, the apparatus including at least one stroller engagement member moveably mounted to the riding board between a stored position and an extended position for engaging a stroller for connecting the apparatus to a stroller, the column being detachably attached to the riding board for removal of the column from the riding board when the riding board is connect to a stroller.

10. The apparatus of claim 1, including a tray pivotally mounted near the upper end of the column, between a collapsed position substantially parallel to the column and a use position extending substantially perpendicularly to the column, the pulling handle being incorporated into an outer end of the tray.

11. The apparatus of claim 1, including a tray pivotally mounted near the upper end of the column, between a collapsed position substantially parallel to the column and a use position extending substantially perpendicularly to the column, the pulling handle being incorporated into an outer end of the tray, the column comprising at least two elongated members that are telescopically engaged with each other for movement from the expanded use position to the shortened collapsed position, an upper one of the elongated members being rotatable about the axis of the column with respect to a lower one of the elongated members so that with the tray in its use position the tray can be rotated about the axis of the column to a position over the riding board.

12. The apparatus of claim 1, including a tray pivotally mounted near the upper end of the column, between a collapsed position substantially parallel to the column and a use position extending substantially perpendicularly to the column, the pulling handle being incorporated into an outer end of the tray, the handle bar comprising a pair of elongated handles on opposite sides of the column, the tray having a first recess on a first side of the tray connected to the column with a pair of space apart projections pivotally connected to respective outer ends of the handles for pivotally connecting the tray to the column.

13. The apparatus of claim 1, including a tray pivotally mounted near the upper end of the column, between a collapsed position substantially parallel to the column and a use position extending substantially perpendicularly to the column, the pulling handle being incorporated into an outer end of the tray, the handle bar comprising a pair of elongated handles on opposite sides of the column, the tray having a first recess on a first side of the tray connected to the column with a pair of space apart projections pivotally connected to respective outer ends of the handles for pivotally connecting the tray to the column, the tray having a second recess on a second side of the tray which is opposite to the first recess, the pull handle extending across the second recess.

14. The apparatus of claim 1, wherein the riding board includes a base attached to the column and a platform pivotally mounted to the base for movement from the substantially horizontal use position which is substantially perpendicular to the column, to the collapsed position which is substantially parallel to the column, first locking means for locking the platform in the use position, the plurality of wheels including a pair of large front wheels mounted for rotation to opposite sides of the base, and a pair of small rear caster wheels mounted for rotation the platform, the rear wheels being foldable from a use position extending substantially perpendicular to the platform, to a collapsed position substantially parallel to the platform and the platform being at least partly between the front, the column comprises at least two elongated members that are telescopically engaged with each other for movement from the expanded use position to the shortened collapsed position, second locking means for locking the column in the expanded use position, the apparatus including at least one stroller engagement member moveably mounted to the riding board between a stored position and an extended position for engaging a stroller for connecting the apparatus to a stroller, and the column being detachably attached to the riding board for removal of the column from the riding board when the riding board is connect to a stroller.

15. The apparatus of claim 1, wherein the riding board includes a base attached to the column and a platform pivotally mounted to the base for movement from the substantially horizontal use position which is substantially perpendicular to the column, to the collapsed position which is substantially parallel to the column, first locking means for locking the platform in the use position, the plurality of wheels including a pair of front wheels mounted for rotation to the base, and a pair of rear wheels mounted for rotation the platform, the column comprising at least two elongated members that are telescopically engaged with each other for movement from the expanded use position to the shortened collapsed position, and second locking means for locking the column in the expanded use position.

16. The apparatus of claim 1, wherein the riding board includes a base attached to the column and a platform pivotally mounted to the base for movement from the substantially horizontal use position which is substantially perpendicular to the column, to the collapsed position which is substantially parallel to the column, first locking means for locking the platform in the use position, the plurality of wheels including a pair of front wheels mounted for rotation to the base, and a pair of rear wheels mounted for rotation the platform, the column comprising at least two elongated members that are telescopically engaged with each other for movement from the expanded use position to the shortened collapsed position, second locking means for locking the column in the expanded use position, the apparatus further including a tray pivotally mounted near the upper end of the column, between a collapsed position substantially parallel to the column and a use position extending substantially perpendicularly to the column, the pulling handle being incorporated into an outer end of the tray, the handle bar comprising a pair of elongated handles on opposite sides of the column, the tray having a first recess on a first side of the tray connected to the column with a pair of space apart projections pivotally connected to respective outer ends of the handles for pivotally connecting the tray to the column, and third locking means for locking the tray in the use position.

17. The apparatus of claim 1, including a tray pivotally mounted near the upper end of the column, between a collapsed position substantially parallel to the column and a use position extending substantially perpendicularly to the column, the pulling handle being incorporated into an outer end of the tray and locking means for locking the tray in the use position.

18. The apparatus of claim 1, including a tray pivotally mounted near the upper end of the column, between a collapsed position substantially parallel to the column and a use position extending substantially perpendicularly to the column, the pulling handle being incorporated into an outer end of the tray, the riding board including a base attached to the column and a platform pivotally mounted to the base for movement from the substantially horizontal use position which is substantially perpendicular to the column, to the collapsed position which is substantially parallel to the column, the plurality of wheels including a pair of front wheels mounted for rotation to the base and at least one rear wheel mounted for rotation the platform, the collapsed position of the platform being on an opposite side of the column from the collapsed position of the tray.

19. The apparatus of claim 1, including a tray pivotally mounted near the upper end of the column, between a collapsed position substantially parallel to the column and a use position extending substantially perpendicularly to the column, the pulling handle being incorporated into an outer end of the tray, the tray also being rotatable mounted to the column for movement from the use position to a stable serving position over the riding board.

20. The apparatus of claim 1, wherein the pull handle comprised an elongated pull handle pivotally connected near the top of the column.
